(19) United States
(12) Patent Application Publication
(10) Pub. No.: US 2026/0054717 A1
(43) Pub. Date: Feb. 26, 2026

(54) COMPUTER-BASED VEHICLE MANAGEMENT THROUGH A VEHICLE-TO-VEHICLE NETWORK

(71) Applicant: INTERNATIONAL BUSINESS MACHINES CORPORATION, ARMONK, NY (US)

(72) Inventors: Yu Zhu, Beijing (CN); Su Liu, Austin, TX (US); Jun Su, Beijing (CN); Peng Hui Jiang, Beijing (CN); Guang Han Sui, Beijing (CN); Jun Feng Duan, Beijing (CN)

(21) Appl. No.: 18/813,111

(22) Filed: Aug. 23, 2024

(51) Int. Cl. B60W 30/09; H04W 4/46

(52) U.S. Cl. CPC B60W 30/09; H04W 4/46

(57) ABSTRACT

In an approach to improve vehicle data management over a vehicle-to-vehicle (V2V) network, computer-implemented methods extract and select collected data according to different needs of an event and one or more travel-related features and exchange the extracted data with other vehicles through the V2V network. Further, the computer-implemented methods categorize received inputs, the collected data and the exchanged data into different categories associated with different events and analyze the categorized inputs to identify a control event. Additionally, the computer-implemented methods determine a specific action is to be performed based on the analysis of the categorized input and identified control event according to predefine rules, and execute the determined specified action.

### BACKGROUND OF THE INVENTION

The present invention relates generally to motorized vehicles, and more particularly to the field of managing vehicles over a vehicle-to-vehicle (V2V) network.

Cars are moving miniature data centers, and they have a multitude of onboard sensors that can capture and send data in real time. IoT connected vehicle sensors and systems can connect millions of cars and integrate big data from other sources, including weather systems, geographic map services, traffic systems, and more. Situational detection for vehicles, drivers, and environmental objects is available as soon as events occur to enable vehicle-to-everything (V2X) solutions, including vehicle-to-vehicle (V2V) communication through a computer-based cloud system. The agent-based data cache and rule engine system provide high performance and low-latency access to vehicle-related data. Vehicle-to-vehicle (V2V) communication is an automobile technology designed for dedicated short-range communication (DSRC) to allow vehicles to communicate with one another. V2V communications utilizes all forms of wireless components and form a vehicular ad hoc network on the road.

### SUMMARY

Embodiments disclose a computer-implemented method, a system, and a computer program product for improving vehicle management over a vehicle-to-vehicle (V2V) network, the computer-implemented method comprising: extracting and selecting collected data according to different needs of an event and one or more travel-related features; exchanging the extracted data with other vehicles through a vehicle to everything (V2X) network, wherein the exchanged extracted data comprises vehicle status, actions taken by the vehicles and environmental data; categorizing received inputs, the collected data and the exchanged data into different categories associated with different events; analyzing the categorized inputs to identify a control event; determining a specific action is to be performed based on the analysis of the categorized input and identified control event according to predefine rules; and executing the determined specified action.

Embodiments further disclose collecting real time data from a plurality of on-vehicle sensors. Embodiments additionally disclose learning statistical relationships between events (action requests) and associated sensor data from related multiple vehicles in V2V network, and training a decision module based on learned statistical relationships for determining a control event from sensor data input/V2X data inputs. Embodiments additionally disclose, wherein analyzing the categorized inputs comprises conducting statistical analysis, descriptive statistics, correlation analysis, regression analysis, clustering, and time series analysis. Embodiments additionally disclose clustering nearby vehicles and grouping them based on analyzed insights and for better understanding the relationships between vehicles, laying the groundwork. Embodiments additionally disclose enabling users to configure vehicle management settings and defining general vehicle management rules related to sensor data and current vehicle parameters. Embodiments further disclose defining an enhanced vehicle management framework for solving problems under flooded V2X information.

### BRIEF DESCRIPTION OF THE DRAWINGS

FIG. 1 is a functional block diagram illustrating a distributed data processing environment, executing a vehicle management program, in accordance with an embodiment of the present invention;

FIG. 2 illustrates a functional block diagram and operational steps of the vehicle management program, on a server computer within the distributed data processing environment of FIG. 1, in accordance with an embodiment of the present invention; and

FIG. 3 illustrates operational steps of the vehicle management program, on a server computer within the distributed data processing environment of FIG. 1, in accordance with an embodiment of the present invention.

### DETAILED DESCRIPTION

According to an aspect of the invention, there is a provided computer-implemented method, computer system, and computer program product to extract and select collected data, associated with a first vehicle, according to different needs of an event and one or more travel-related features, exchange the extracted data with one or more second vehicles through a vehicle to everything (V2X) network, wherein the exchanged extracted data comprises vehicle status, actions taken by the one or more second vehicles and environmental data, categorize received inputs, the collected data and the exchanged data into different categories associated with different events, analyze the categorized inputs to identify a control event, determine a specific action is required based on the analysis of the categorized inputs and identified control event according to predefine rules, and execute the determined specified action.

According to an aspect of the invention, the provided computer-implemented method, computer system, and computer program product may further comprise collecting real time data from a plurality of on-vehicle sensors of the first vehicle.

In embodiments, the provided computer-implemented method, computer system, and computer program product may further comprise learning statistical relationships between events (action requests) and associated sensor data from the first vehicle and the one or more second vehicles connected by the V2X network, and training a decision module based on learned statistical relationships for determining a control event from sensor data input and V2X data inputs.

In embodiments, the analyzing of the categorized inputs comprises conducting statistical analysis, descriptive statistics, correlation analysis, regression analysis, clustering, and time series analysis.

In embodiments, the provided computer-implemented method, computer system, and computer program product may further comprise clustering the one or more second vehicles and grouping data associated with the one or more second vehicles based on analyzed insights, wherein the analyzed insights comprise position, speed, direction, displacement, route, and destination of the one or more second vehicles.

In embodiments, the provided computer-implemented method, computer system, and computer program product may further comprise enabling users to configure vehicle management settings and defining general vehicle management rules related to sensor data and current vehicle parameters.

In embodiments, the provided computer-implemented method, computer system, and computer program product may further comprise defining an enhanced vehicle management framework for solving problems under flooded V2X information.

Vehicle-to-vehicle (V2V) networks brings great advantage to exchange information among multiple vehicles. However, embodiments recognize that there are constantly more and more sensors being added on vehicles, while utilizing and managing the data collected from these sensors and other vehicles is a problem. For example, there are issues, currently in the art, on how to utilize the collected and communicated data associated with vehicles and V2V communication to make a decision and execute one or more vehicle controlling actions. Embodiments recognize that a vehicle can also manually or automatically trigger functions based on sensor detection result such as switching on headlights when the sensors detect light in the surrounding area is below a predetermined threshold. However, embodiments recognize that there are multiple scenarios which could not be satisfied by current solutions known in the art. For example, on a mildly foggy day, it is difficult to decide if you need to turn on the fog lights when another vehicle switches their fog lights on but the sensors on the user's vehicle show it is unnecessary to activate on the fog lights. In another example, when driving on highway with high speed, a first driver may not have enough time to stop the car when they see the second driver apply the brake lights or an autonomous vehicle may struggle to parse and analyze the information to effectively apply the breaks when identifying the second user is applying the breaks.

Embodiments improve the art and solve, at least, the particular issues stated above by facilitating enhanced vehicle management via vehicle to vehicle (V2V) network for determining a specific action based on analyzing insights external control requests.

Embodiments improve the art and solve, at least, the particular issues stated above by (i) collecting real time data (e.g., vehicle speed, fuel consumption rate, battery consumption rate, fuel tank capacity, battery capacity, battery charging rate, driver behavior data, special requirement in driving such as noisy level, e.g., road condition, traffic status, regulation area, weather information, etc.) from on-vehicle sensors; (ii) extracting and selecting collected data according to different needs of events and travel-related features; (iii) exchanging the extracted data with other vehicles thought V2X network including vehicle status, actions taken and environmental data; (iv) categorizing all inputs, collected data (sensor data input) and exchanged data (V2V data input) into different categories associated with different events; (v) learning statistical relationships between events (action requests) and associated sensor data from related multiple vehicles in V2V network; (vi) training a decision module based on learned statistical relationships for determining a control event from sensor data input/V2X data inputs; (vii) analyzing the categorized inputs (e.g., statistical analysis, descriptive statistics, correlation analysis, regression analysis, clustering, time series analysis, etc.) to identify a control event/requests (turn-on fog light) by using a trained event determination model; (viii) clustering nearby vehicles and grouping them based on analyzed insights and (position, speed, direction, displacement, etc.) for better understanding the relationships between vehicles, laying the groundwork; (ix) determining whether specific actions (turn-on of turn-off fog lights, adjust driving speed) are to be performed according to predefine rules, analyzed insights/real time requests; (x) recommending, alerting, and suggesting an action according to the determined action, and executing the determined action manually or automatically; (xi) enabling users to configure vehicle management settings and defining general vehicle management rules related to sensor data and current vehicle parameters; and (xii) defining an enhanced vehicle management framework for solving problems under flooded V2X information.

In embodiments, component 150 provides a vehicle management method not only based on current status data of the user vehicle (e.g., a first vehicle), but also based on statistical result of event based clustered vehicles data. For example, in one scenario, suppose there is a car accident 500 m ahead in the same line as the user's vehicle. The accident is out of user's sight, and the vehicle ahead of the user's vehicle may keep driving at a current rate of travel. In current autonomous vehicle solution, there is no sign to take any action from either the Lidar or other sensors. However, in embodiments a user's vehicle will receive and/or retrieve the vehicles data and identify a plurality of vehicles in same lane deaccelerate and even start to brake. Some embodiments will receive and/or determine the insight of an event occurring ahead of the user's vehicle and perform an action to deaccelerate or turn into other lane.

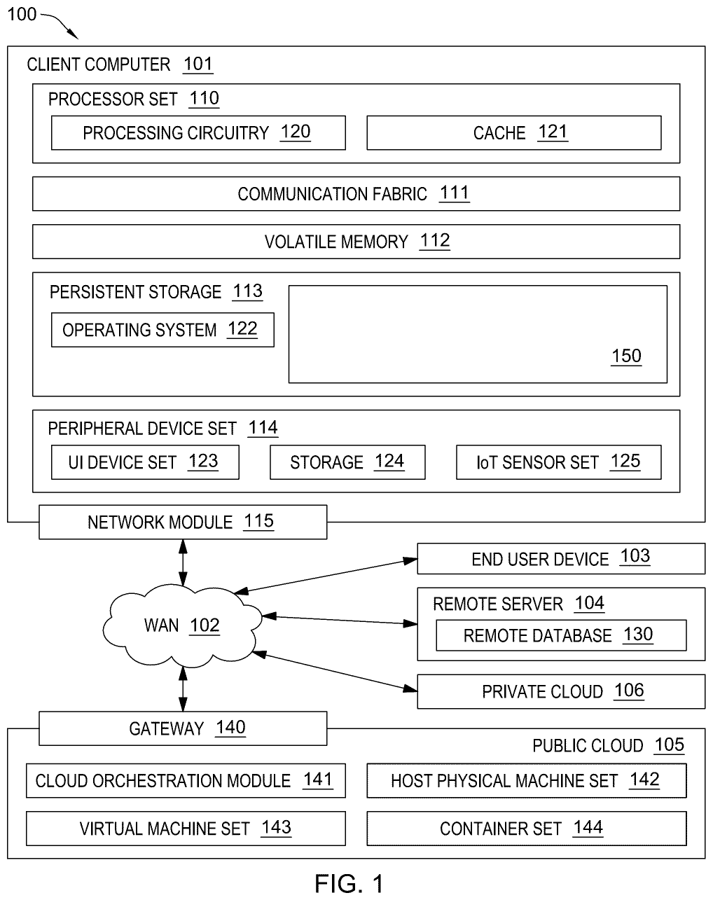

Implementation of embodiments of the invention may take a variety of forms, and exemplary implementation details are discussed subsequently with reference to the Figures (i.e., FIG. 1-FIG. 3).

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails, and texts, and/or responsive display prompts begin with a written notification that the user's information may be recorded or monitored and may be saved, for the purpose of consolidating shipments to reduce carbon emissions and shipping costs. These embodiments may also include periodic reminders of such recording and monitoring throughout the course of any such use. Certain embodiments may also include regular (e.g., daily, weekly, monthly) reminders to the participating parties that they have consented to being recorded and monitored for collision avoidance and autonomous vehicle safety measures and may provide the participating parties with the opportunity to opt-out of such recording and monitoring if desired.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as vehicle management program (component) 150. In addition to component 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and component 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips.

Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in component 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in component 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. IoT sensor set 125 may be any combination of proximity sensors, image sensor, motion sensor, thermistor, capacity sensing, photoelectric sensor, infrared sensor, level sensor, humidity sensor, pressure sensor, temperature sensor, and/or any sensor and/or IoT sensor known and understood in the art.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Component 150 improves the art and solve, at least, the particular issues stated above by creating an enhanced vehicle management via V2V Network for determining whether a specific action is is to be performed based on the analyzed insights external control requests. Component 150 accomplishes this by (i) collecting the real time data (e.g., vehicle speed, fuel consumption rate, battery consumption rate, fuel tank capacity, battery capacity, battery charging rate, driver behavior data, special requirement in driving such as noisy level, e.g., road condition, traffic status, regulation area, weather information, etc.) from on-vehicle sensors, (ii) extracting and selecting collected data according to different needs of events and travel-related features, (iii) exchanging the extracted data with other vehicles thought V2X network, wherein the extracted data comprises vehicle status, actions taken and environmental data, (iv) categorizing all inputs, collected data (sensor data input) and exchanged data (V2V data input) into different categories associated with different events, (v) analyzing the categorized inputs to identify a control event/requests (turn-on fog light) by using a trained event determination model, wherein the analysis comprises statistical analysis to gain insights (motion and behavioral patterns of vehicles) from the extracted data, and wherein one or more of the analyzes are performed using the extracted data, such as descriptive statistics, correlation analysis, regression analysis, clustering, time series analysis, and/or any other features that are known and understood in the art, (vi) clustering nearby vehicles and group them based on analyzed insights and indicators (position, speed, direction, displacement, route, and destination of the one or more second vehicles) for better understanding the relationships between vehicles, laying the groundwork, wherein in vehicle clustering, component 150 analyzes the motion and behavioral patterns of vehicles to determine if they belong to the same convoy, lane, or follow similar traffic rules, (vii) determining whether specific actions (turn-on of turn-off fog lights, adjust driving speed) are to be performed according to predefine rules, analyzed insights and/or real time requests, (viii) recommending, alerting, and suggesting a proper action according to the determined action, and (ix) executing the determined action manually or automatically.

Additionally, component 150 may further improve the art and solve, at least, the particular issues stated above by (i) learning statistical relationships between events (action requests) and associated sensor data from related multiple vehicles in v2v network, (ii) training a decision module based on learned statistical relationships for determining a control event from Sensor data input or/and V2X data inputs, (iii) enabling users to configure Vehicle Management settings and define general Vehicle Management rules. The rules related to sensor data and current vehicle parameters, (iv) defining a V2X communication network for exchanging data with vehicles around. The data comprises vehicle status, actions taken and environmental information, and (v) defining an enhanced vehicle management framework for solving decision anxiety problem under flooded V2X information.

For example, during foggy road conditions, the sensor system on a first vehicle detects that there is no need to turn on fog lights on the first vehicle. However, in this example, a second car traveling behind the first vehicle, within a predetermined distance of the first vehicle, sends a request, via a V2V network, to the first vehicle to turn on the fog taillights associated with the first vehicle. In this example, responsive to receiving the request from the second vehicle, to turn on the tail lights, component 150 collects the fog light status from all connected vehicles surrounding it within a predetermined parameter and obtain sensor data associated with illumination, utilizes machine learning, via an embedded decision module to calculate the statistical data of one or more fog lights from the vehicles within the predetermined parameter and the illumination data by the weight module defined for this type of event, and determining, by the decision module, whether the fog taillight of the first vehicle should be turned on. In the particular example, responsive to determining the fog taillight of the first vehicle should be turned on based on the calculation, turning on the taillights of the first vehicle.

In another example, a first vehicle traveling at 50 miles per hour receives, from a V2V network, the speed information from other vehicles within a predetermined distance of the first vehicle. In this example, component 150 continuously collects speed information from the other vehicles within a predetermined distance of the first vehicle and obtain regulation data for current segment. In this example, component 150, via an embedded decision module, identifies that the speed of surrounding vehicles, within a predetermined distance of the first vehicle, is 55 miles per hour (mph) and that the speed limit is 55 mph on the current road is 55 mph. In this particular example, component 150, via the decision module, determines, based on the identified speed of the other vehicles and identified speed limit that it is safter for the first vehicle to increase its speed to 55 mph. In this particular example, executes the accelerator and increases the speed of the first vehicle to 55 mph. In this example, component 150 receives, from V2V network, a slowdown action from other vehicles within a predetermined area, wherein, responsive to receiving the slowdown action from the other vehicles, component 150 collects, via V2V network, speed information from the other vehicles in front of the first vehicle. In this example, embedded decision module identifies, based on the collected data and V2V communication, that eighteen of twenty vehicles that are in front of the first vehicle are deaccelerating (e.g., stopped applying the accelerator and/or are applying a breaking system). In this example, responsive to identifying that vehicles are deaccelerating in front of the first vehicle, component 150, via decision module, determines that the first vehicle should also deaccelerate, wherein responsive to determining the first vehicle should also deaccelerate, component 150 stops applying the accelerator and applies the breaking system to match the other vehicles and/or prevent a collision while simultaneously outputting a notification to driver of the first vehicle. In another example, component 150 collects, via V2V network, speed information from the other vehicles in the same lane that are in front of the first vehicle.

In various embodiments, component 150 monitors the actions of other vehicles connected to the V2V network that are within a predetermined distance of a first vehicle. In some embodiments, responsive to identifying, via the V2V network, that a predetermined number of vehicles within a predetermined distance of a first vehicle apply one or more deaccelerating actions, component 150 outputs a notification of the deacceleration action of the other vehicles to all the vehicles connected to the V2V network that are within a predetermined distance of the first vehicle.

In various embodiments, component 150 collects status data from nearby vehicles and utilize a machine learning based statistical model to calculate the event based clustered vehicle data, and combine the calculated event with current vehicle data to make a decision on a action to perform. For example, while on the highway, if component 150 identifies that one or more secondary vehicles that are ahead of the first vehicle are traveling over speed limit by 5 km/h then the speed data from the secondary vehicles ahead of the first vehicle are collected and sent to a statistical model and where a decision to accelerate and match the secondary vehicles or stay at the current speed of travel is made. In some embodiments, component 150 ignores the data collected from secondary vehicles that are traveling behind the first vehicle.

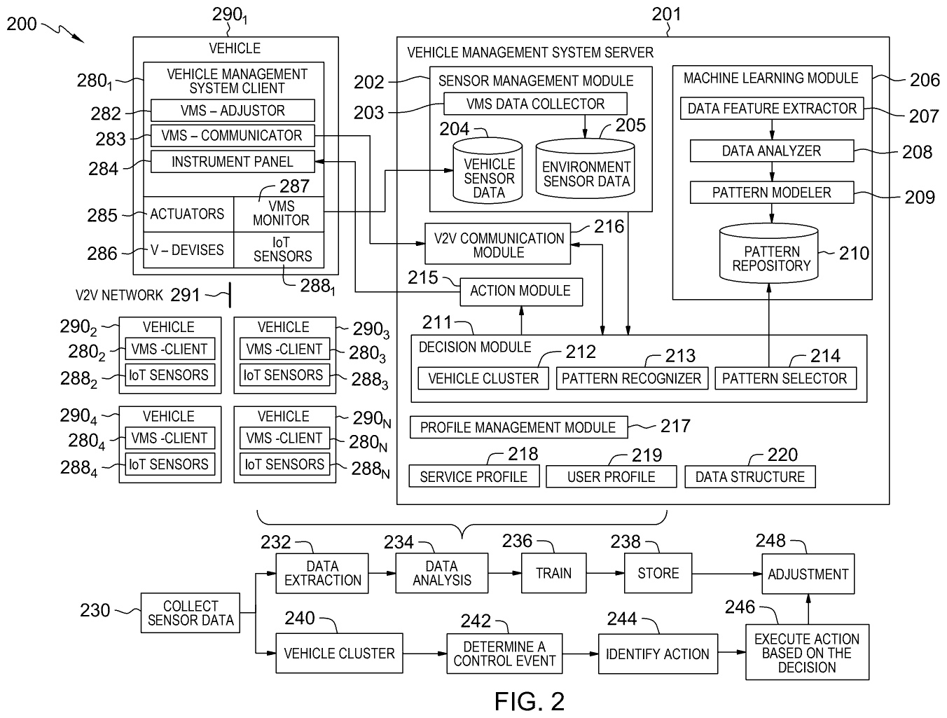

FIG. 2 is a functional block diagram illustrating a distributed data processing environment, generally designated 200, in accordance with one embodiment of the present invention. The term “distributed” as used in this specification describes a computer system that includes multiple, physically distinct devices that operate together as a single computer system. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 200 includes interconnected computing environment comprises vehicle 290₁, 290₂, 290₃, 290₄, 290_{N}, and vehicle management system (VMS) server 201 interconnected through a wireless network (e.g., V2V network 291) and/or a wired system or a combination of the two. In the depicted embodiment, vehicle 290₁ comprises vehicle management system (VMS) client 280₁, V-devices 286, and IoT sensors 288₁, wherein VMS client 280₁ comprises VMS adjustor 282, VMS communicator 283, instrument panel 284, actuators 285, and VMS monitor 287. As used herein, N represents a positive integer, and accordingly the number of scenarios implemented in a given embodiment of the present invention is not limited to those depicted in FIG. 2. In the depicted embodiment, vehicle 290₂ comprises VMS client 280₂ and IoT sensors 288₂, vehicle 290₃ comprises VMS client 280₃ and IoT sensors 288₃, vehicle 290₄ comprises VMS client 280₄ and IoT sensors 288₄, vehicle 290_{N} comprises VMS client 280_{N} and IoT sensors 288_{N}.

In the depicted embodiment, component 150 collects sensor data 230 from vehicle 290₁, vehicle 290₂, vehicle 290₃, vehicle 290₄, and vehicle 290_{N}. On the VMS Client 280₁ side, component 150 monitors vehicle data through VMS Monitor 287 to capture real-time vehicle data through IoT sensors 288₁ (e.g., vehicle speed, fuel consumption rate, battery consumption rate, fuel tank capacity, battery capacity, battery charging rate (time) and so on.), and user data (e.g., driver behavior data, special requirement in driving such as noisy level . . . ). In the depicted embodiment, component 150 sends the captured data to the Sensor Management Module 202 on the VMS Server 201 side for data, stored in Vehicle Sensor Data (204) processing and analysis. In various embodiments, VMS Data Collector 203 retrieves traffic data (e.g., road condition, traffic status, regulation area, weather information) from the vehicle to everything (V2X) network, and traffic data stored in the Environment Sensor Data 205.

In the depicted embodiment, component 150 executes data extraction 232 from vehicle 290₁, vehicle 290₂, vehicle 290₃, vehicle 290₄, and vehicle 290_{N}. In various embodiments, sensor data from vehicle 290₁, vehicle 290₂, vehicle 290₃, vehicle 290₄, and vehicle 290_{N} is transmitted to the Machine Learning Module 206. Machine learning module comprises data feature extractor 207, data analyzer 208, pattern modeler 209, and pattern repository 210. Data Feature Extractor 207 selects and transforms raw data into relevant features that can be used for analysis, wherein relevant features are predetermined and/or customizable. The feature extraction performed by data feature extractor 207 comprises various aspects related to travel and vehicle behavior. Some specific features for extraction comprise: travel-related features, (travel time, duration of each trip segment; distance covered in each segment, etc.), route information (details about the roads taken, including road types (highways, local roads), traffic density, and elevation changes, etc.), weather conditions (temperature, precipitation, humidity, and visibility during travel, etc.), temporal features (timestamps, time and date of travel segments, day of the week, extracting the day of the week can help identify patterns related to weekdays vs. weekends), spatial features (geographical coordinates, and/or latitude and longitude information for the starting and ending points of each segment that can be used for mapping routes.).

In the depicted embodiment, component 150 executes data analysis 234. In various embodiments, component 150 utilize data analyzer 208 to perform statistical analysis to gain insights from the extracted data. One or more of the specific analyses are performed using the extracted data, such as descriptive statistics, correlation analysis, regression analysis, clustering, time series analysis, and/or any other analysis known and understood in the art.

In the depicted embodiment, component 150 trains 236 a hybrid algorithm. In various embodiments, component 150 utilizes Pattern Modeler (209) to train the hybrid algorithm using the sensor data. The algorithm learns to predict segments based on the input parameters and user's preferences. The input parameters and user's preferences are stored 238 so that they can be retrieved and utilized for training and fine-tuning. Fine-tune hyperparameters of the hybrid algorithm are utilized to ensure prediction on suggested vehicle indicator and are stored 238 in the Pattern Repository (210). Train-Validation-Test Split comprise splitting the preprocessed historical data into three subsets: a training set (70-80%), a validation set (10-15%), and a test set (10-15%). The training set is used to train the model, the validation set is used to fine-tune hyperparameters, and the test set is kept separate for final evaluation. K-Fold Cross-Validation comprises implementing K-fold cross-validation on the training data, splitting the training data into K subsets (folds) and training the model K times, wherein each time, of the K times, utilizes a different fold as the validation set. The average of the performance metrics across the K folds is utilized to obtain a robust estimation of the model's performance.

In the depicted embodiment, component 150 clusters vehicle data 240 from vehicle 290₁, vehicle 290₂, vehicle 290₃, vehicle 290₄, and vehicle 290_{N}. In various embodiments, different groups of vehicle data are used for different control events. The clustering of vehicle data groups and filters the vehicle data based on current and/or predicted positions of the vehicle and/or a control event. Fo example, when driving down a highway vehicles traveling in the same lane within a predetermined distance are clustered together to create cluster vehicle data based on collected and aggregated vehicle data of the vehicles in the cluster. In the depicted embodiment, component 150 communicates one or more vehicles' request/response using the VMS Communicator 283 on VMS client 280₁ and the V2V Communication Module 216 on VMS server 201. Information exchanged among the vehicles'request are but not limited to vehicle status or request on actions. In the depicted embodiment, component 150 In various embodiments, component 150, via decision module 211, determines whether specific actions are to be performed based on vehicle data, or control event is encountered. For example, determining whether it is necessary to turn on the head lights or emergency lights, determining whether to change lanes, control the change of driving speed, and determine whether to take other vehicle actions. In some embodiments, executed vehicle actions are responsive to received data from the surrounding traffic. In the depicted embodiment, collected sensor data is transmitted from the Sensor Management Module 202 to the decision module 211, wherein vehicle cluster 212 automatically groups nearby vehicles (i.e., other vehicles within a predetermined distance from a first vehicle) based on indicators such as position, speed, direction, displacement, and/or any other indicators known and understood in the art. Vehicle clustering, performed by vehicle cluster 212, aims to categorize or group vehicles based on identified dynamic characteristics. This categorization enables component 150 understand the relationships between vehicles and facilitates the utilization and improvement of driver assistance features or traffic management. In vehicle clustering, component 150 analyzes the motion and behavioral patterns of vehicles (e.g., vehicles connected via V2V network 291 that are within a predetermined distance from each other) to determine if they belong to the same convoy, lane, or follow similar traffic rules.

In the depicted embodiment, component 150 determines, via decision module 211, a control event 242 based on the collected and clustered vehicle data. In various embodiments, responsive to receiving or establishing one or more sets of vehicle cluster data and a data stream being continuously monitored, component 150 recognizes, through pattern recognizer 213, patterns within the vehicle cluster data and/or data stream. During real-time monitoring, component 150 matches the current vehicle behavior data with the identified patterns and previously stored patterns stored in pattern repository 210. In the depicted embodiment, component 150 utilizes patter selector 214 to identify patterns in data stored in pattern repository 210. Pattern selector 214 utilizes the comprehensive pattern Repository to efficiently identify and correlate patterns relevant to the current vehicle behavior data. This component serves as a link, enabling the system to dynamically select and apply patterns from the repository that best match the real-time characteristics of the monitored vehicle cluster. This adaptive functionality contributes to component 150 ability to respond intelligently to diverse driving scenarios, enhancing its overall performance and providing insights for decision-making. In various embodiment, component 150 utilizes the one or more identified patterns between the collected data, clustered vehicle data, live data stream data, and previously stored pattern data to determine a control event.

In the depicted embodiment, component 150 identifies an action 244 for the control event. In the depicted embodiment, component 150 pushes the selected pattern to the Action Module (215), where associated response or action to a certain pattern is designed. In various embodiments, the action will be determined based on the analysis result of the potential event, e.g., the fog light need to be turned on now. Continuing the fog light example, the action instruction will be sent to and/or retrieved by component 150 to execute as: (i) turn on the fog light, (ii) botify user in either visual or audible manner, and (iii) update the vehicle status information for exchanging.

In the depicted embodiment, component 150 executes an action based on a decision 246 (i.e., the identified action). In various embodiments, responsive to receiving an identified action/action request from action module 215, component 150, via actuators 285, executes the action, wherein the action is a vehicle related operation. In the depicted embodiment, the action request is transmitted to the Instrument Panel 284 on the VMS Client 280₁ and either by manual or through automation process designed in Actuators 285, specific actions are executed in certain vehicles. For example, turn on the running lights, change lanes, control the change of driving speed, and determine whether to take other traffic behaviors.

In the depicted embodiment, component 150 adjust the action 248. In various embodiments, component 150, via VMS adjustor 282, enables a user to interact with the suggested or applied action. In various embodiments, the user adjusts his preferences through VMS client 280₁ and component 150 collects feedback from user after and/or during a trip, wherein feedback comprises, but is not limited to, the accuracy of predictions and overall satisfaction. In various embodiments, component 150 utilizes this feedback for continuous improvement of the model. Component 150 enables administrators and users to configure and edit profile data and user preferences through Profile Management Module 217, wherein profile management module 217 comprises Service Profile 218 (such as enable or disable), User Profile 219, and Data structure 220, and wherein each of Service Profile 218, User Profile 219, and Data structure 220 are calculated by different weight. In various embodiments, component 150 stores the received and/or calculated adjustments, collectively referred to as the adjustments, on to a repository wherein the adjustments utilized to train the machine learning model and to identify patterns between collected, received, identified, and stored data.

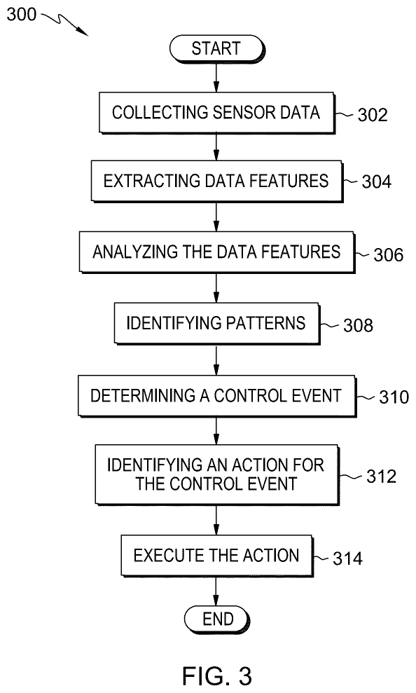

FIG. 3 illustrates operational steps of component 150, generally designated 300, in communication with client computer 101, remote server 104, private cloud 106, EUD 103, client computer 101, and/or public cloud 105, within distributed data processing environment 100, for managing vehicles data over a vehicle-to-vehicle (V2V) network, the computer-implemented method, in accordance with an embodiment of the present invention. FIG. 3 provides an illustration of one implementation and does not imply any limitations with regard to the environments in which different embodiments may be implemented. Many modifications to the depicted environment may be made by those skilled in the art without departing from the scope of the invention as recited by the claims.

In block 302, component 150 collects sensor data. In various embodiments, component 150 collects sensor data from a first vehicle and one or more secondary vehicles that are within a predetermined distance from the first vehicle and that are connected to a V2V network. In various embodiments, component 150 collects sensor data, wherein on the VMS Client side of a vehicle, component 150 monitors the vehicle data through the VMS monitor to capture real-time vehicle data through one or more IoT sensors (e.g., vehicle speed, fuel consumption rate, battery consumption rate, fuel tank capacity, battery capacity, battery charging rate (time) and so on.), and user data (e.g., driver behavior data, special requirement in driving such as noisy level . . . ). In the depicted embodiment, component 150 sends the captured/collected data to a sensor management module on the VMS server side for data, stored on vehicle sensor data processing and analysis. In various embodiments, VMS data collector retrieves traffic data (e.g., road condition, traffic status, regulation area, weather information) from the vehicle to everything (V2X) network, and traffic data stored in the environment sensor data. In various embodiments, component 150 clusters vehicle data. In various embodiment, component 150 communicates one or more vehicles'request/response using the VMS Communicator on the VMS client and the V2V Communication Module on VMS server. Information exchanged among the vehicles'request are but not limited to vehicle status or request on actions. Vehicle clustering, performed by a vehicle cluster, aims to categorize or group vehicles based on identified dynamic characteristics. This categorization enables component 150 understand the relationships between vehicles and facilitates the utilization and improvement of driver assistance features or traffic management. In vehicle clustering, component 150 analyzes the motion and behavioral patterns of vehicles (e.g., vehicles connected via V2V network that are within a predetermined distance from each other) to determine if they belong to the same convoy, lane, or follow similar traffic rules.

In block 304, component 150 extract data features from the collected and/or clustered data. In various embodiments, component 150 executes data extraction on the collected data. In various embodiments, sensor data is transmitted to a machine learning module. The Machine learning module comprises a data feature extractor, data analyzer, pattern modeler, and pattern repository. The data feature extractor selects and transforms raw data into relevant features that can be used for analysis, wherein relevant features are features that match an identified and/or predicted action. For example, if the extracted features from the collected and clustered data signal a deacceleration of vehicles than the relevant features are features that pertain and are associated with deacceleration. In some embodiments, the relevant features are predetermined. The feature extraction performed by the data feature extractor comprises various aspects related to travel and vehicle behavior. Some specific features for extraction comprise, but are not limited to, travel-related features, (travel time, duration of each trip segment; distance covered in each segment, etc.), route information (details about the roads taken, including road types (highways, local roads), traffic density, and elevation changes, etc.), weather conditions (temperature, precipitation, humidity, and visibility during travel, etc.), temporal features (timestamps, time and date of travel segments, day of the week, extracting the day of the week can help identify patterns related to weekdays vs. weekends), spatial features (geographical coordinates, and/or latitude and longitude information for the starting and ending points of each segment that can be used for mapping routes.).

In block 306, component 150 analyzes the data features. In various embodiment, component 150 executes data analysis on the extracted data associated with the collected and/or clustered data. In various embodiments, component 150 utilizes a data analyzer to perform statistical analysis to gain insights from the extracted data. In various embodiments, the insight is an anticipated event from the result of statistical analysis. For example, fog light is necessary or potential accident ahead. One or more of the specific analyses are performed using the extracted data, such as descriptive statistics, correlation analysis, regression analysis, clustering, time series analysis, and/or any other analysis known and understood in the art.

In block 308, component 150 identifies patterns. In various embodiments, responsive to receiving or establishing one or more sets of vehicle cluster data and a data stream being continuously monitored, component 150 recognizes, through a pattern recognizer, patterns within the vehicle cluster data and/or data stream. During real-time monitoring, component 150 matches the current vehicle behavior data with the identified patterns and previously stored patterns stored in the pattern repository. In the depicted embodiment, component 150 utilizes a patter selector to identify patterns in data stored in the pattern repository. The pattern selector utilizes the comprehensive pattern repository to efficiently identify and correlate patterns relevant to the current vehicle behavior data. The patter selector enables component 150 to dynamically select and apply patterns from the pattern repository that matches, within a predetermined range of acceptance, the real-time characteristics of the monitored vehicle cluster. The adaptive functionality contributes to component 150 ability to respond intelligently to diverse driving scenarios, enhancing its overall performance and providing insights for decision-making. In various embodiment, component 150 utilizes the one or more identified patterns between the collected data, clustered vehicle data, live data stream data, and previously stored pattern data to determine a control event.

In various embodiment, component 150 trains a machine learning model with the data and identified patterns in the previous blocks. In various embodiments, component 150 trains a machine learning model with the data and identified patterns in the previous blocks, wherein the machine learning model is a hybrid algorithm. In various embodiments, component 150 utilizes pattern modeler to train the hybrid algorithm using the sensor data.

The machine learning model learns to predict segments based on the input parameters and user's preferences. The input parameters and user's preferences are stored so that they can be retrieved and utilized for training and fine-tuning. Fine-tune hyperparameters of the hybrid algorithm are utilized to ensure prediction on suggested vehicle indicator and are stored in the pattern repository. Train-Validation-Test Split comprise splitting the preprocessed historical data into three subsets: a training set (70-80%), a validation set (10-15%), and a test set (10-15%). The training set is used to train the model, the validation set is used to fine-tune hyperparameters, and the test set is kept separate for final evaluation. K-Fold Cross-Validation comprises implementing K-fold cross-validation on the training data, splitting the training data into K subsets (folds) and training the model K times, wherein each time, of the K times, utilizes a different fold as the validation set. The average of the performance metrics across the K folds is utilized to obtain a robust estimation of the model's performance.

In block 310, component 150 determines a control event based on the identified pattern. In various embodiments, component 150 determines, via decision module, a control event based on the collected and clustered vehicle data. In various embodiments, responsive to receiving or establishing one or more sets of vehicle cluster data and a data stream being continuously monitored, component 150 recognizes, through the pattern recognizer, patterns within the vehicle cluster data and/or data stream. During real-time monitoring, component 150 matches the current vehicle behavior data with the identified patterns and previously stored patterns stored in pattern repository 210. In various embodiments, component 150, via a decision module, determines whether specific actions are to be performed based on vehicle data, or control event is encountered. For example, determining whether it is necessary to turn on the head lights or emergency lights, determining whether to change lanes, control the change of driving speed, and determine whether to take other vehicle actions. In some embodiments, executed vehicle actions are responsive to received data from the surrounding traffic. In the depicted embodiment, collected sensor data is transmitted from the sensor management module to the decision module, wherein the vehicle cluster automatically groups nearby vehicles (i.e., other vehicles within a predetermined distance from a first vehicle) based on indicators such as position, speed, direction, displacement, route, destination of the one or more second vehicles, and/or any other indicators known and understood in the art.

In block 312, component 150 identifies an action for the control event. In various embodiment, component 150 identifies an action for the control event based on the identified control event of the vehicle and/or surrounding vehicles. In various embodiments, component 150 communicates within one or more modules in the vehicle (e.g., sends a request to one or more modules in the vehicle). In various embodiment, component 150 pushes the selected pattern to an action module, where an associated response or action to a certain pattern is assigned and/or queued so that the vehicle is enabled to perform the identified action.

In block 314, component 150 executes the identified action. In various embodiments, component 150 executes the identified action based on the identified decision (e.g., turning on headlights, applying the breaks, accelerating, any/or any other action or combination of actions known and understood in the art). In various embodiments, responsive to receiving an identified action/action request from the action module, component 150, via one or more actuators, executes the action, wherein the action is a vehicle related operation. In the depicted embodiment, the action request is transmitted to the instrument panel on the VMS Client and either by manual or through automation process designed in the one or more actuators, specific actions are executed in certain vehicles. For example, turn on the running lights, change lanes, control the change of driving speed, and determine whether to take other traffic behaviors.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
extracting and selecting collected data, associated with a first vehicle, according to different needs of an event and one or more travel-related features;
exchanging the extracted data with one or more second vehicles through a vehicle to everything (V2X) network, wherein the exchanged extracted data comprises vehicle status, actions taken by the one or more second vehicles and environmental data;
categorizing received inputs, the collected data and the exchanged data into different categories associated with different events;
analyzing the categorized inputs to identify a control event;
determining a specific action is to be performed based on the analysis of the categorized inputs and identified control event according to predefine rules; and
executing the determined specified action.

2. The computer-implemented method of claim 1, further comprising:
collecting real time data from a plurality of on-vehicle sensors of the first vehicle.

3. The computer-implemented method of claim 1, further comprising:
learning statistical relationships between events (action requests) and associated sensor data from the first vehicle and the one or more second vehicles connected by the V2X network; and
training a decision module based on learned statistical relationships for determining a control event from sensor data input and V2X data inputs.

4. The computer-implemented method of claim 1, wherein analyzing the categorized inputs comprises conducting statistical analysis, descriptive statistics, correlation analysis, regression analysis, clustering, and time series analysis.

5. The computer-implemented method of claim 1, further comprising:
clustering the one or more second vehicles and grouping data associated with the one or more second vehicles based on analyzed insights, wherein the analyzed insights comprise position, speed, direction, displacement, route, and destination of the one or more second vehicles.

6. The computer-implemented method of claim 1, further comprising:
enabling users to configure vehicle management settings and defining general vehicle management rules related to sensor data and current vehicle parameters.

7. The computer-implemented method of claim 1, further comprising:
defining an enhanced vehicle management framework for solving problems under flooded V2X information.

8. A computer system comprising:
one or more computer processors;
one or more computer readable storage devices;
program instructions to extract and selecting collected data, associated with a first vehicle, according to different needs of an event and one or more travel-related features;
program instructions to exchange the extracted data with one or more second vehicles through a vehicle to everything (V2X) network, wherein the exchanged extracted data comprises vehicle status, actions taken by the one or more second vehicles and environmental data;
program instructions to categorize received inputs, the collected data and the exchanged data into different categories associated with different events;
program instructions to analyze the categorized inputs to identify a control event;
program instructions to determine a specific action is to be performed based on the analysis of the categorized input and identified control event according to predefine rules; and
program instructions to execute the determined specified action.

9. The computer system of claim 8, further comprising:
collecting real time data from a plurality of on-vehicle sensors of the first vehicle.

10. The computer system of claim 8, further comprising:
program instructions to learn statistical relationships between events (action requests) and associated sensor data from the first vehicle and the one or more second vehicles connected by the V2X network; and
program instructions to train a decision module based on learned statistical relationships for determining a control event from sensor data input and V2X data inputs.

11. The computer system of claim 8, wherein analyzing the categorized inputs comprises conducting statistical analysis, descriptive statistics, correlation analysis, regression analysis, clustering, and time series analysis.

12. The computer system of claim 8, further comprising:
program instructions to cluster the one or more second vehicles and grouping data associated with the one or more second vehicles based on analyzed insights, wherein the analyzed insights comprise position, speed, direction, displacement, route, and destination of the one or more second vehicles.

13. The computer system of claim 8, further comprising:
program instructions to enable users to configure vehicle management settings and defining general vehicle management rules related to sensor data and current vehicle parameters.

14. The computer system of claim 8, further comprising:
program instructions to define an enhanced vehicle management framework for solving problems under flooded V2X information.

15. A computer program product comprising:
one or more computer readable storage devices and program instructions stored on the one or more computer readable storage devices, the stored program instructions comprising:
program instructions to extract and selecting collected data, associated with a first vehicle, according to different needs of an event and one or more travel-related features;
program instructions to exchange the extracted data with one or more second vehicles through a vehicle to everything (V2X) network, wherein the exchanged extracted data comprises vehicle status, actions taken by the one or more second vehicles and environmental data;
program instructions to categorize received inputs, the collected data and the exchanged data into different categories associated with different events;
program instructions to analyze the categorized inputs to identify a control event;
program instructions to determine a specific action is to be performed based on the analysis of the categorized input and identified control event according to predefine rules; and
program instructions to execute the determined specified action.

16. The computer program product of claim 15, further comprising:
collecting real time data from a plurality of on-vehicle sensors of the first vehicle.

17. The computer program product of claim 15, further comprising:
program instructions to learn statistical relationships between events (action requests) and associated sensor data from the first vehicle and the one or more second vehicles connected by the V2X network; and
program instructions to train a decision module based on learned statistical relationships for determining a control event from sensor data input and V2X data inputs.

18. The computer program product of claim 15, wherein analyzing the categorized inputs comprises conducting statistical analysis, descriptive statistics, correlation analysis, regression analysis, clustering, and time series analysis.

19. The computer program product of claim 15, further comprising:
program instructions to cluster the one or more second vehicles and grouping data associated with the one or more second vehicles based on analyzed insights, wherein the analyzed insights comprise position, speed, direction, displacement, route, and destination of the one or more second vehicles.

20. The computer program product of claim 15, further comprising:
program instructions to enable users to configure vehicle management settings and defining general vehicle management rules related to sensor data and current vehicle parameters; and
program instructions to define an enhanced vehicle management framework for solving problems under flooded V2X information.
